(19) United States
(12) Patent Application Publication
(10) Pub. No.: US 2006/0231369 A1
(43) Pub. Date: Oct. 19, 2006

(54) Clutch disc assembly with direct bond ceramic friction material

(75) Inventors: Michael L. Bassett, Auburn, IN (US); Steven J. Rynearson JR., Angola, IN (US)

Correspondence Address: Kevin M. Hinman, 26201 Northwestern Hwy., P.O. Box 766, Southfield, MI, 48037, US

(73) Assignee: Eaton Corporation, Cleveland, OH (US)

(21) Appl. No.: 11/396,445

(22) Filed: Apr. 3, 2006

Related U.S. Application Data
(60) Provisional application No. 60/671,854, filed on Apr. 15, 2005.

(51) Int. Cl. F16D 13/64; F16D 69/02; F16D 69/04

(52) U.S. Cl. 192/107 M; 192/107 C; 192/212

(57) ABSTRACT

A clutch disc assembly for a friction torque device has a clutch damper assembly which includes a hub defining an axis of rotation. The damper assembly includes a plurality of cushion elements extending radially outwardly away from the axis of rotation. A first friction ring includes a backer plate fixed to the cushion elements by circumferentially distributed rivets. At least one ceramic friction element is bonded to the backer plate.

### RELATED APPLICATIONS

This application claims the benefit of U.S. Provisional Application No. 60/671,854, filed Apr. 15, 2005 entitled “Clutch Disc Assembly With Direct Bond Ceramic Friction Material”, which is incorporated herein by reference in its entirety.

### FIELD OF THE INVENTION

The present invention relates to clutch disc assemblies. More specifically, the present invention relates to the mounting of friction materials on clutch disc assemblies and to the arrangement of friction material on a clutch disc assembly.

### BACKGROUND OF THE INVENTION

Motor vehicle clutch driven disc assemblies, or simply clutch disc assemblies, typically employ two types of friction materials—ceramic and/or organic. Organic friction materials are inherently softer than ceramic materials, deflecting more on engagement. This makes it easier to engage a clutch with organic material than with ceramic material without undesired harshness and without stalling the vehicle's engine. Organic materials wear faster than ceramic materials. However, ceramic materials wear the engagement surfaces of the engaging plate element, commonly a machined cast iron surface, faster than organic materials. Ceramics materials are able to sustain higher temperatures and higher loads than organic friction materials, making ceramics attractive for certain heavy-duty applications in spite of the wear and engagement concerns. Clutch disc assemblies with ceramic friction material have tended to be higher in inertia than organic material clutch disc assemblies because of the friction material mounting techniques commonly employed, particularly when rivets are used to retain the friction material to a backing plate. Ceramic discs have also been assembled in a fashion sufficiently different from the assembly of organic discs that more is required to switch between organic and ceramic than simply exchanging a ceramic friction ring for an organic friction ring or vice versa. It is desired to provide a lower inertia clutch disc assembly employing ceramic friction material. It is also desired to provide a clutch driven disc employing ceramic material which has approximately the same axial thickness as an organic material clutch disc assembly. It is also desired to provide a clutch driven disc employing ceramic friction material which can be assembled using the same tooling and assembly processes as an organic material clutch. It is also desired to provide a clutch disc assembly having some or all of the benefits of both ceramic clutch disc assemblies and organic clutch disc assemblies. It is further desired to provide a clutch disc assembly that has the wear characteristics of organic on a clutch flywheel.

### SUMMARY OF THE INVENTION

The present invention provides a lower clutch inertia disc employing ceramic friction material. The present invention also provides a clutch disc assembly in which it is possible to easily switch between ceramic and organic material. The present invention also provides a clutch which has approximately the same axial thickness as an organic material clutch disc assembly. The present invention also provides a clutch disc assembly having some or all of the benefits of both ceramic clutch disc assemblies and organic clutch disc assemblies. The present invention also provides a clutch disc assembly that has the wear characteristics of organic on a clutch flywheel.

A clutch disc assembly for a friction torque device has a clutch damper assembly with a hub which defines an axis of rotation. The damper assembly includes a plurality of cushion elements extending radially outwardly away from the axis of rotation. The cushion elements collectively have a first set and a second set of receiving apertures. A first friction ring has a plurality of circumferentially distributed clearance apertures and receiving apertures, and is fixed to the cushion elements concentric with the axis of rotation. The receiving apertures of the first friction ring are in alignment with the first set of apertures of the cushion elements. A second friction ring has a plurality of circumferentially distributed clearance apertures and receives apertures. The second friction ring is fixed to the cushion elements concentric with the axis of rotation with the receiving apertures of the second friction ring in alignment with the second set of apertures of the cushion elements. At least one of the first friction ring and the second friction ring include an annular backer plate having the plurality of circumferentially distributed clearance apertures and receiving apertures, as well as a plurality of circumferentially distributed friction pads formed of ceramic material bonded to the backer plate at locations between the apertures. A first plurality of rivets is disposed in a plurality of the receiving apertures of the first friction ring and a corresponding plurality of the first set of apertures in the cushion element. A second plurality of rivets is disposed in a plurality of the receiving apertures of the second friction ring and a corresponding plurality of the second set of apertures in the cushion element, thereby fixing the backer plates to the cushion elements.

A clutch disc assembly for a friction torque device has a clutch damper assembly which includes a hub defining an axis of rotation. The damper assembly includes a mounting feature extending radially outwardly away from the axis of rotation. A first friction ring is fixed to the mounting feature concentric with the axis of rotation and includes organic friction material and exclusive of ceramic friction material. A second friction ring is fixed to the mounting feature concentric with the axis of rotation and includes ceramic friction material.

Further objects, features and advantages of the present invention will become apparent to those skilled in the art from analysis of the following written description, the accompanying drawings and appended claims.

### BRIEF DESCRIPTION OF THE DRAWINGS

FIG. 1 is a side elevational view of and transmission and clutch illustrating the environment of the present invention.

FIG. 2 is a partially exploded view of a clutch disc assembly of the present invention.

FIG. 3 is a close-up perspective view of the clutch disc assembly of FIG. 2.

FIG. 4 is a close-up side view of a second embodiment of the present invention.

FIG. 5 is an end view of the clutch disc assembly of FIG. 4 in the direction of arrow 5.

FIG. 6 is a sectional side view of a friction ring of FIG. 2 in the direction of arrows 6.

FIG. 7 is a partial angle view of an alternative embodiment a clutch disc assembly without one of its friction rings.

FIG. 8 is a sectional side view of the clutch disc assembly of FIG. 7 with both of its friction ring in the direction of arrows 8.

### DETAILED DESCRIPTION OF THE PREFERRED EMBODIMENT

Certain terminology will be used in the following description for convenience in reference only and will not be limiting. For example, the terms “forward” and “rearward” will refer to directions forward and rearward of a transmission as normally mounted in a vehicle. The terms “rightward” and “leftward” will refer to directions in the drawings in connection with which the terminology is used. The terms “inwardly” and “outwardly” will refer to directions toward and away from, respectively, the geometric center of the apparatus. The terms “upward” and “downward” will refer to directions as taken in the drawings in connection with which the terminology is used. All foregoing terms mentioned above include the normal derivatives and equivalents thereof.

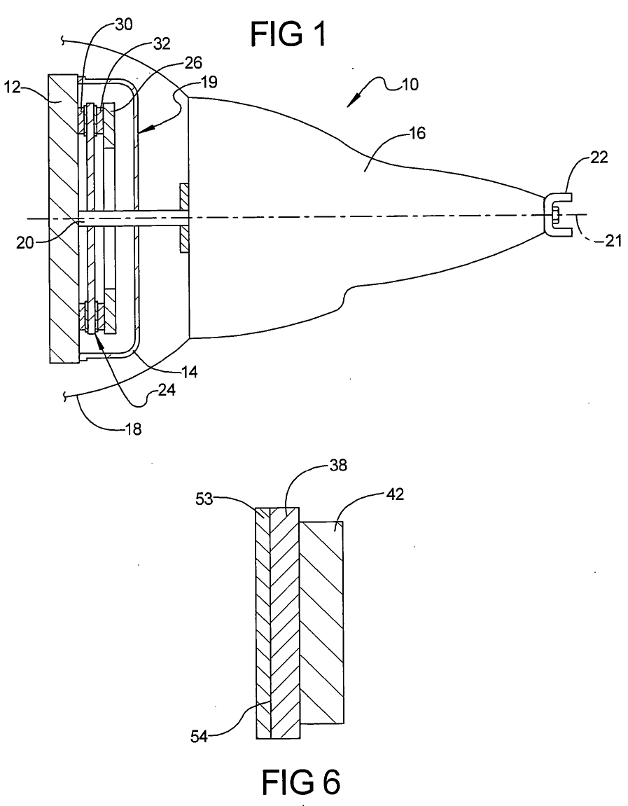

Referring to FIG. 1 of the drawings, a partial cross-sectional view of a clutch/transmission assembly 10 is shown. An engine flywheel 12 is rotatably coupled to a clutch cover 14. A gear change transmission 16 is nonrotatably mounted to a bellhousing 18 which is mounted to an engine block (not shown). A clutch assembly 19 including clutch cover 14 and engine flywheel 12 is disposed within bellhousing 18. The transmission 16 is driven through the rotation of a transmission input shaft 20 about an axis 21 which eventually rotates a transmission drive yoke 22 which is attached to the balance of the vehicle driveline (not shown).

The transmission input shaft 20 is rotated by the flywheel 12 through frictional engagement of a clutch disc assembly 24 with flywheel 12. The clutch disc assembly 24 is typically nonrotatably slideably mounted to the input shaft 20 of the gear change transmission 16 and disposed between engine flywheel 12 and a clutch pressure plate 26 of assembly 19. Commonly shaft 20 and disc assembly 24 have complementary mating splines enabling disc assembly 24 to axially slide along shaft 20 while rotating as a unit therewith.

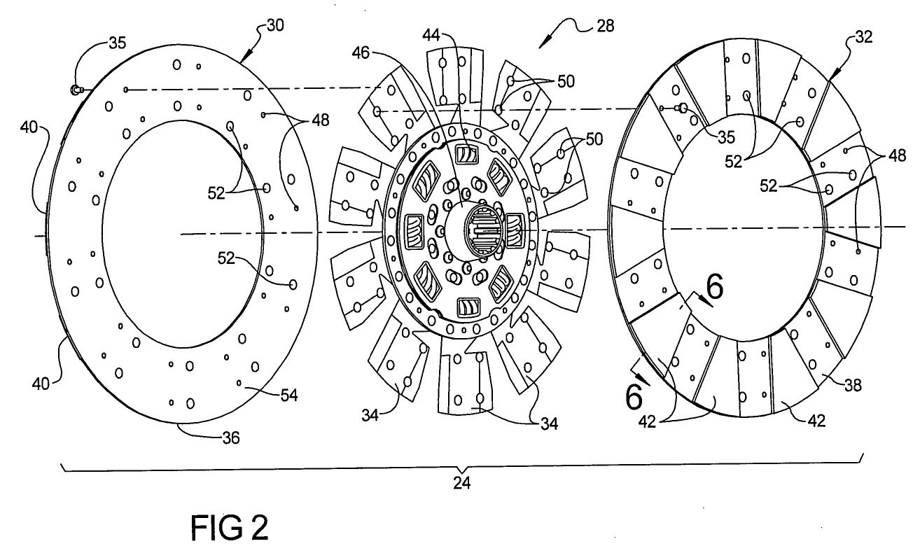

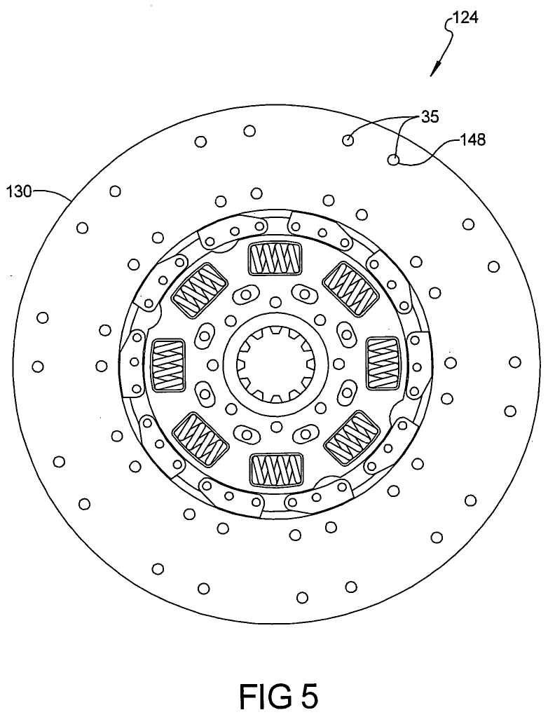

Referring now to FIG. 2, a partially exploded view of clutch disc assembly 24 is shown. As shown in FIG. 5, assembly 24 comprises three main sub assemblies: a clutch damper assembly 28, and first and second friction rings 30 and 32 respectively. Damper assembly 28 has a plurality of radially extending cushion elements 34 to which rings 30 and 32 are fixed by rivets 35.

First and second friction rings 30 and 32 each include first and second backer plates 36 and 38 respectively. Backer plates 36 and 38 are formed of steel. A plurality of first friction pads 40 are fixed to first backer plate 36, and a plurality of second friction pads 42 are fixed to second backer plate 38.

Clutch damper assembly 28 is typical of such assemblies found in clutches, and is not important in its details. Damping elements 44 in the form of springs are distributed circumferentially about assembly 28. Damping elements 44 are selected to cushion or damp out driveline torsional impulses when disc assembly 24 is clamped between pressure plate 26 and flywheel 12 in a clutch-engaged condition. Assembly 28 is configured to permit a limited amount of relative rotation between a splined hub 46 and friction rings 30 and 32. Hub 46 is slideaby disposed on complementary splined input shaft 24 and rotates as a unit therewith. Friction rings are engaged by pressure plate 26 and flywheel 12 and rotate as a unit therewith in a clutch-engaged condition. Damping elements 44 are functionally disposed between hub and friction rings 30, 32 in a manner well known in the art to provide the desired isolation between the engine flywheel 12 and the transmission input shaft 20.

Cushion elements 34 are well known in the art and can be provide in a wide variety of forms. Cushion elements 34 are formed of steel and resiliently axially separate rings 30 and 32. The axially separation provisions a cushion effect on clutch engagement which aids in modulating clutch engagement to facilitate smooth clutch engagement. Alternative cushion element configurations equally suited to the purpose are readily found in the prior art. Both backer plates 36, 38 and cushion elements 34 have a plurality of aligned receiving apertures 48 and 50 respectively of slightly larger diameter than the body or shank of rivets 35 to enable the body but not the head of rivets to pass there through. Receiving apertures 50 through cushion elements in alignment with rivets 35 connecting first friction ring 30 to cushion elements 34 constitute a first set of receiving apertures in cushion elements. Receiving apertures 50 through cushion elements in alignment with rivets 35 connecting second friction ring 32 to cushion elements 34 constitute a second set of apertures. First and second engagement areas of cushion elements 34 are axially spaced from each other and are defined, respectively, by the areas most proximate to apertures 50 in alignment with apertures 48 of first friction ring 30 and with aperture 50 in alignment with apertures 48 of second friction ring 32. A plurality of clearance apertures 52, sized slightly larger than the heads or the formed upsets of rivets 35, are formed in backer plates 36 and 38. The clearance apertures 52 in the backer plates 36, 38 are in alignment with the aligned apertures of the opposite backer plate as best seen in FIG. 2. The clearance aperture 52 receives the rivet upset, or alternatively, the rivet head when the clutch disc assembly 24 is fully compressed in the axial direction.

Clutch friction material is commonly classified as either organic or ceramic. Alternative or equivalent characterizations of ceramic friction material are metallic and cerametalic. In this application, the term ceramic will be used generically for any friction materials in the clutch art which may be characterized as any of ceramic, metallic or cerametalic. Organic material is generally characterized as being easier to achieve modulated clutch engagements with. Ceramic material is generally characterized as being relatively difficult to achieve smooth clutch engagements with. Part of this difference may be attributable to the organic material generally being able to deflect more under the clutch engagement loads than the ceramic material. Organic material causes less wear of the engagement surfaces of the pressure plate and flywheel. Ceramic material is generally considered more wear resistant than organic material, and to enable a higher torque transmission capacity for a give diametral size and clamp load.

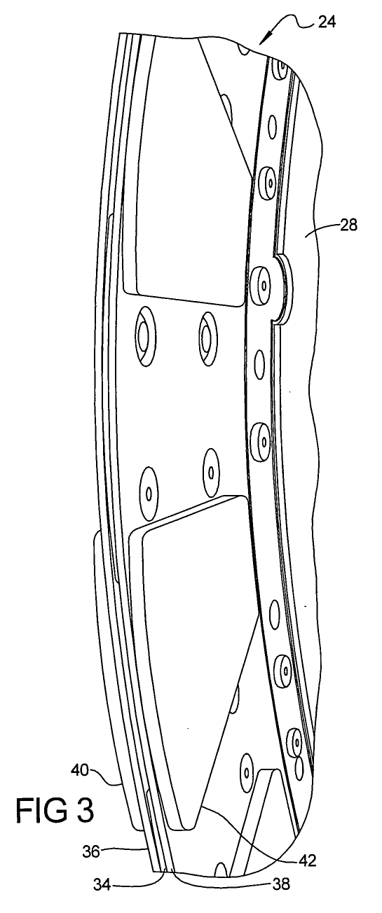

The embodiment of FIGS. 1 through 3 has identical friction rings 30 and 32. Friction pads 40 and 42 are accordingly identical and are formed of ceramic material. Direct bonding of friction pads 40 and 42 to annular backer plates 36 and 38 results in a thinner driven disc and identical friction rings than that which is typical for cushioned ceramic material driven discs. Thinner disc assemblies 24 are possible because the rivets do not pass through the friction pads, and the friction pads 42 do not need to provide an engagement surface for rivets 35. The precise method of bonding is not critical to this invention. Two possible methods of bonding include applying a brazing paste to either the backer plates 36, 38 or the friction pads 40, 42 and heating an area of contact between the friction pads 40, 42 and the backer plates 36, 38 causing the brazing paste to liquefy and bond the friction pads 40, 42 to the backer plates 36, 38. Another method is to form the friction pads 40, 42 directly on the backer plates 36, 38 by depositing powdered friction material on the backer plates 36, 38 and subjecting the powdered friction material to heat and pressure so that the friction material sinters or fuses to the backer plates 36, 38 and forms the friction pads 40, 42. The powdered friction material is retained by forms during compression so it does not spread beyond the desired shape of the friction pads 40, 42.

Backer plates 36, 38 may be beneficially provided with a coat of insulating material 53 to reduce the frictional heat generated during clutch engagement transferred to the cushion elements 34. Excessive heating of cushioning elements can result in diminished cushioning capability. In one embodiment, the insulating material 53 is on a side 54 of the backer plate engaging cushion elements 34. The insulating material 53 needs to provide resistance to the transmission of heat, but needs not be especially resistant to stress. Insulating material 53 can include but is not limited to fiberglass, cork and any phenolic material. Additional insulation may be provided by insulating grommets disposed between the rivets and the joint between the facing and the cushion elements 34. The grommets could be in the form of a coating over the rivet.

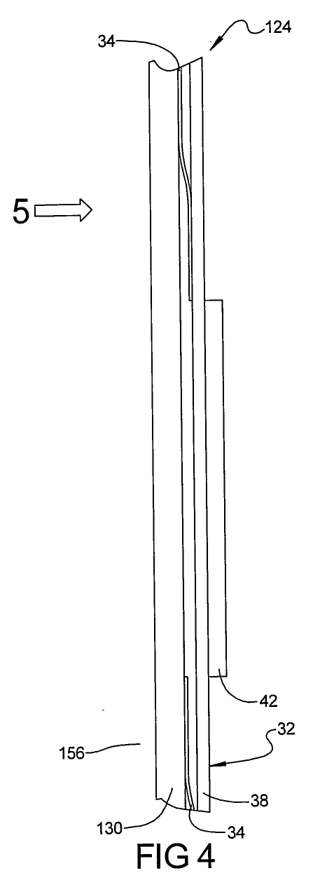

A second embodiment of the present invention, as best seen in FIG. 4 and FIG. 5, has organic facing material on a first side of 1 clutch disc assembly 124, and ceramic facing material on the second side of the driven disc. The organic facing material by itself defines a friction ring 130. Friction ring 130 has a plurality of circumferentially distributed receiving apertures 148. Friction ring 130 is riveted to engaging cushion elements 34 by rivets 35. Receiving apertures 148 are countersunk to enable the head or upset of rivets 35 to be disposed below an engagement surface 156 of friction ring 130. Alternatively, organic material ring 130 could be bonded to metal backer plate with receiving apertures passing through the backer plate and rivets 35 engaging the backer plate.

In the clutch assembly, driven disc 24 has its organic friction ring 130 disposed towards engine flywheel 12 and ceramic friction ring 32 disposed toward pressure plate 26. As a result of this orientation, the clutch advantageously provides engagement characteristics similar to those of a ceramic clutch, while the wear on the flywheel is the same as that of an organic disc. As a result, the pressure plate sustains more wear than the flywheel over the life of a flywheel disc. This allows a service technician to replace to replace the cover 14 and pressure plate 26 assembly, and to leave the relatively lightly worn flywheel 12 in place for continued service. This significantly reduces the effort needed to service a worn clutch.

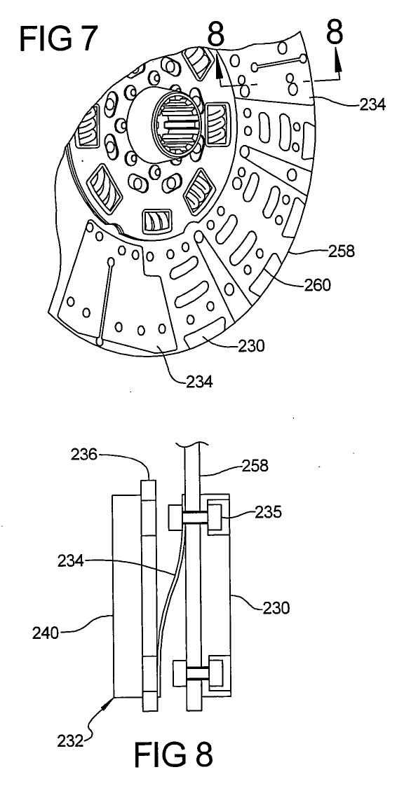

Yet another embodiment is shown in FIGS. 7 and 8. A perforated steel disc 258 extends radial from clutch damper assembly. An organic material friction ring 230 is fixed to a first side of the steel disc 258 by a plurality of rivets 235. A plurality of cushion elements 234 are fixed to the steel disc 258 on a side opposite the organic material friction ring 230. A ceramic material friction ring 232 comprising a steel backer plate 236 with ceramic friction material 240 disposed thereon is fixed to the cushion elements 234 opposite the steel disc 258 by rivets (not shown). The ceramic friction material 240 can be either in the form of pads or in the form of an annular ring. Balance weights may be selectively placed in dovetail shaped insert slots 260 within disc 258.

Direct bonding of ceramic friction material 240 to an annular steel ring instead of direct bonding friction material to smaller backer discrete arcuate elements which are in turn mounted separately to the clutch assembly, as done in the prior art, has several benefits. Discrete elements are more prone to hot spots and resultant warpage of the arcuate backer elements. Once source of hot spots will be the variation in displacement due to variation in the cushion elements. In a single arcuate ring, the variation is minimized because the unitary rings prevent any single cushion element from creating too much localized displacement. Additionally, having unitary rings results in a stronger structure for the clutch disc. The invention results in a more consistent cushion rate than with arcuate elements.

The foregoing discussion discloses and describes the preferred embodiment of the present invention. However, one skilled in the art will readily recognize from such discussion and the accompanying drawings and claims that various changes, modifications and variations can be made therein without departing from the true spirit and fair scope of the invention as defined in the following claims.

We claim:

1. A clutch disc assembly for a friction torque device, comprising:
a clutch damper assembly including a hub defining an axis of rotation and including a plurality of cushion elements extending radially outwardly away from the axis of rotation with the cushion elements collectively having a first set and a second set of receiving apertures;
a first friction ring having a plurality of circumferentially distributed clearance apertures and receiving apertures and fixed to the cushion elements concentric with the axis of rotation with the receiving apertures of the first friction ring in alignment with the first set of apertures of the cushion elements;
a second friction ring having a plurality of circumferentially distributed clearance apertures and receiving apertures and fixed to the cushion elements concentric with the axis of rotation with the receiving apertures of the second friction ring in alignment with the second set of apertures of the cushion elements;
at least one of the first friction ring and the second friction ring including an annular backer plate having the plurality of circumferentially distributed clearance apertures and receiving apertures and having a plurality of circumferentially distributed friction pads formed of ceramic material bonded to the backer plate at locations between the apertures;
a first plurality of rivets disposed in a plurality of the receiving apertures of the first friction ring and a corresponding plurality of the first set of apertures in the cushion element; and
a second plurality of rivets disposed in a plurality of the receiving apertures of the second friction ring and a corresponding plurality of the second set of apertures in the cushion element, thereby fixing the backer plates to the cushion elements.

2. A clutch disc assembly as claimed in claim 1 wherein the at least one of the first friction ring and the second friction ring has a coating of insulating material on a side opposite the friction pads.

3. A clutch disc assembly for a friction torque device, comprising:
a clutch damper assembly including a hub defining an axis of rotation and including a plurality of cushion elements extending radially outwardly away from the axis of rotation with the cushion elements collectively having a first set and a second set of receiving apertures;
a first friction ring having a plurality of circumferentially distributed clearance apertures and receiving apertures and fixed to the cushion elements concentric with the axis of rotation with the receiving apertures of the first friction ring in alignment with the first set of apertures of the cushion elements;
a second friction ring having a plurality of circumferentially distributed clearance apertures and receiving apertures and fixed to the cushion elements concentric with the axis of rotation with the receiving apertures of the second friction ring in alignment with the second set of apertures of the cushion elements;
each of the first friction ring and the second friction ring including an annular backer plate having the plurality of circumferentially distributed clearance apertures and receiving apertures and having a plurality of circumferentially distributed friction pads formed of ceramic material bonded to the backer plate at locations between the apertures;
a first plurality of rivets disposed in a plurality of the receiving apertures of the first friction ring and a corresponding plurality of the first set of apertures in the cushion element; and
a second plurality of rivets disposed in a plurality of the receiving apertures of the second friction ring and a corresponding plurality of the second set of apertures in the cushion element, thereby fixing the backer plates to the cushion elements.

4. A clutch disc assembly as claimed in claim 3 wherein each of the first friction ring and the second friction ring has a coating of insulating material on a side opposite the friction pads.

5. A clutch disc assembly for a friction torque device, comprising:
a clutch damper assembly including a hub defining an axis of rotation and including a mounting feature extending radially outwardly away from the axis of rotation;
a first friction ring fixed to the mounting feature elements concentric with the axis of rotation and including organic friction material and exclusive of ceramic friction material; and
a second friction ring fixed to the mounting feature concentric with the axis of rotation and including ceramic friction material.

6. A clutch disc assembly for a friction torque device, comprising:
a clutch damper assembly including a hub defining an axis of rotation and including a plurality of cushion elements extending radially outwardly away from the axis of rotation with the cushion elements collectively having a first set and a second set of receiving apertures;
a first friction ring having a plurality of circumferentially distributed clearance apertures and receiving apertures and fixed to the cushion elements concentric with the axis of rotation with the receiving apertures of the first friction ring in alignment with the first set of apertures of the cushion elements;
a second friction ring having a plurality of circumferentially distributed clearance apertures and receiving apertures and fixed to the cushion elements concentric with the axis of rotation with the receiving apertures of the second friction ring in alignment with the second set of apertures of the cushion elements;
the first friction ring including organic friction material and exclusive of ceramic friction material and the first friction ring having the plurality of circumferentially distributed clearance apertures and receiving apertures;
the second friction ring including an annular backer plate having the plurality of circumferentially distributed clearance apertures and receiving apertures and having a plurality of circumferentially distributed friction pads formed of ceramic material bonded to the backer plate at locations between the apertures;
a first plurality of rivets disposed in a plurality of the receiving apertures of the first friction ring and a corresponding plurality of the first set of apertures in the cushion element; and
a second plurality of rivets disposed in a plurality of the receiving apertures of the second friction ring and a corresponding plurality of the second set of apertures in the cushion element, thereby fixing the backer plates to the cushion elements.

7. A clutch disc assembly for a friction torque device, comprising:
a clutch damper assembly including a hub defining an axis of rotation and including a plurality of cushion elements extending radially outwardly away from the axis of rotation and having axially spaced first and second engagement areas;
a first friction ring fixed to the cushion elements at the first engagement areas and including organic friction material exclusive of ceramic friction material;
a second friction ring fixed to the cushion elements at the second engagement areas and including ceramic friction material and axially separate from the first friction ring by the cushion elements;
at least one of the first and second friction rings including an annular backing plate, the annular backing plate being disposed toward and engaging the cushion elements.
